(19) United States
(12) Patent Application Publication
(10) Pub. No.: US 2021/0065027 A1
(43) Pub. Date: Mar. 4, 2021

(54) DETERMINATION DEVICE, DETERMINATION METHOD, AND RECORDING MEDIUM WITH DETERMINATION PROGRAM RECORDED THEREIN

(71) Applicant: NEC CORPORATION, Tokyo (JP)

(72) Inventor: Kazeto YAMAMOTO, Tokyo (JP)

(73) Assignee: NEC CORPORATION, Tokyo (JP)

(21) Appl. No.: 16/961,108

(22) PCT Filed: Jan. 10, 2018
(86) PCT No.: PCT/JP2018/000262

§ 371 Date: Jul. 9, 2020

(51) Int. Cl. G06N 5/04; A63F 13/67

(52) U.S. Cl. CPC G06N 5/041; G06Q 50/04; A63F 13/67

(57) ABSTRACT

A determination device is provided with: a hypothesis preparation unit which prepares, according to a prescribed hypothesis preparation procedure, a hypothesis that includes a plurality of logical expressions that indicate a relationship between first information for indicating a certain state among a plurality of states related to a target system, and second information for indicating a target state related to the target system; a conversion unit which obtains, according to a prescribed conversion procedure, an intermediate state that indicates a logical expression different from a logical expression related to the first information among the plurality of logical expressions included in the hypothesis; and a low level planner which determines actions up to the intermediate state obtained from the certain state on the basis of a state-related reward in the plurality of states.

### TECHNICAL FIELD

The present invention relates to a determination device and a determination method and, furthermore, relates to a recording medium with a determination program recorded therein.

### BACKGROUND ART

Reinforcement Learning is a kind of machine learning and deals with a problem in which an agent in an environment observes a current state of the environment and determines actions to be carried out. By selecting the actions, the agent gets a reward corresponding to the actions from the environment. The reinforcement learning learns a Policy such that the maximum reward is obtained through a series of actions. The environment is also called a controlled target or a target system.

In the reinforcement learning in a complicated environment, a huge amount of calculation time required in learning tends to become a large bottleneck. As one of variations of the reinforcement learning for resolving such a problem, there is a framework called a “hierarchical reinforcement learning” in which the learning is improved in efficiency by preliminarily limiting, using a different model, a range to be searched and by performing the learning in such limited search space by a reinforcement learning agent. The model for limiting the search space is called a high-level planner whereas a reinforcement learning model for performing the learning in the search space presented by the high-level planner is called a low-level planner.

As one of hierarchical reinforcement learning methods, a method for improving a learning efficiency of the reinforcement learning by using a system of automated planning as the high-level planner is proposed. For example, Non-Patent Literature 1 discloses one of those methods for improving the learning efficiency of the reinforcement learning. In Non-Patent literature 1, Answer Set Programming, which is one of logical deductive inference models, is used as the high-level planner. A situation is supposed in which knowledge related to the environment is preliminarily given as an inference rule and policy for making the environment (target system) reach a target state from a starting state is learned using the reinforcement learning. In this event, in Non-Patent Literature 1, the high-level planner at first enumerates by inference, using the Answer Set Programming and the inference rule, a set of intermediate states through which the environment (target system) possibly passes on the way from the starting state to the target state. The respective intermediate states are called subgoals. In consideration of a group of subgoals presented by the high-level planner, the low-level planner learns the policy such that the environment (target system) reaches the target state from the starting state. Herein, the group of subgoals may be a set or may be an array having a sequential order or a tree structure.

An abduction is an inference method for deriving, based on existing knowledge, a hypothesis which explains an observed fact. In other words, the abduction is an inference to derive the best explanation for a given observation. In recent years, due to tremendous improvement in processing speed, the abduction has been carried out using a computer.

Non-Patent Literature 2 discloses one example of abduction methods using the computer. In Non-Patent Literature 2, the abduction is carried out using a hypothesis candidate generation means and a hypothesis candidate evaluation means. Specifically, the hypothesis candidate generation means receives an observation logical expression (Observation) and a knowledge base (Background knowledge) and generates a set of hypothesis candidates (Candidate hypotheses). The hypothesis candidate evaluation means evaluates probability of the individual hypothesis candidates to select, from the set of the generated hypothesis candidates, a hypothesis candidate which can best explain the observation logical expression without excess or deficiency, and produces it. Such a best hypothesis candidate as the explanation for the observation logical expression is called a Solution hypothesis or the like.

In most abductions, the observation logical expression is given a parameter (cost) indicating “which observation information is emphasized”. The knowledge base stores inference knowledge and individual inference knowledge (Axiom) is given parameters (Weights) indicative of “reliability with which an antecedent is true when a consequent is true.” In evaluation of probability of the hypothesis candidate, an evaluated value (Evaluation) is calculated in consideration of these parameters.

### CITATION LIST

Non-Patent Literatures
NPL 1: Matteo Leonetti, et al. “A Synthesis of Automated Planning and Reinforcement Learning for Efficient, Robust Decision-Making”, Artificial Intelligence (AIJ), Volume 241, pp. 103-130, December 2016.
NPL 2: Naoya Inoue and Kentaro Inui, “ILP-based Reasoning for Weighted Abduction”, In Proceedings of AAAI Workshop on Plan, Activity and Intent Recognition, pp. 25-32, August 2011.

### SUMMARY OF THE INVENTION

### Technical Problem

In the hierarchical reinforcement learning, an inference model, which has been used as the high-level planner until now, requires, as a prior condition, that all of information necessary for inference is completely collected. Therefore, there is a problem that, in an environment for which all of observations are not given, for example, in a case of application to a task based on a partially observable Markov decision process, it is impossible to give an appropriate subgoal.

This results from a cause that any of these inference models is a model based on a propositional logic and it is impossible to suppose an entity, which does not exist in observation, in the middle of inference as necessary. For instance, in Non-Patent Literature 2, Answer Set Programming is used. Inference based on a first-order predicate logic in the Answer Set Programming is implemented by conversion into an equivalent propositional logic using the Herbrand's theorem. Therefore, in the Answer Set Programming also, it is impossible to suppose the entity, which is not observed, in the middle of inference as necessary.

### Object of Invention

It is an object of the present invention to provide a determination device which is capable of resolving the above-mentioned problem.

### Solution to Problem

As an aspect of the present invention, a determination device comprises a hypothesis preparation unit configured to prepare, according to a predetermined hypothesis preparation procedure, a hypothesis including a plurality of logical expressions indicative of a relationship between first information indicative of a certain state among a plurality of states related to a target system and second information indicative of a target state related to the target system; a conversion unit configured to calculate, according to a predetermined conversion procedure, an intermediate state indicated by a logical expression different from a logical expression related to the first information, among the plurality of logical expressions included in the hypothesis; and a low-level planner configured to determine, based on a state-related reward in the plurality of states, actions from the certain state up to the calculated intermediate state.

### Advantageous Effects of Invention

According to the present invention, it is possible to shorten a learning time by reducing the number of trials.

### BRIEF DESCRIPTION OF THE DRAWINGS

FIG. 1 is a view for illustrating an example of narrative, observation, and a rule of background knowledge;

FIG. 2 is a view for illustrating an example which is obtained, for a case of the example of FIG. 1, by hypothesizing with a second rule traced back in an opposite direction;

FIG. 3 is a view for illustrating an example which is obtained, for the case of the example of FIG. 1, by further hypothesizing with a first rule traced back from a state of FIG. 2 in the opposite direction and by performing unification;

FIG. 4 is a view for illustrating a model which is finally inferred, for the case of the example of FIG. 1, via the states of FIGS. 2 and 3;

FIG. 5 is a view for illustrating an example which is obtained by modeling from a current state and a final state in a planning task;

FIG. 6 is a block diagram for illustrating a reinforcement learning system including a determination device of a related art and implementing reinforcement learning;

FIG. 7 is a block diagram for illustrating a hierarchical reinforcement learning system including a determination device, which illustrates an overview of the present invention;

FIG. 8 is a flow chart for use in describing an operation of the hierarchical reinforcement learning system illustrated in FIG. 7;

FIG. 9 is a block diagram for illustrating a configuration of a determination device according to a first example embodiment of the present invention;

FIG. 10 is a flow chart for illustrating an operation of the determination device according to the first example embodiment of the present invention;

FIG. 11 is a flow chart for illustrating an operation of a high-level planner in FIG. 9;

FIG. 12 is a flow chart for illustrating an operation of a determination device according to a second example embodiment of the present invention;

FIG. 13 is a flow chart for illustrating an operation of a determination device according to a third example embodiment of the present invention;

FIG. 14 is a view for illustrating an example of a field in a toy task of an example;

FIG. 15 is a view for illustrating an example of a reword table;

FIG. 16 is a view for illustrating an example of a crafting rule;

FIG. 17 is a view for illustrating a list of definitions of predicates (predicates indicative of states of an environment and an agent and predicates indicative of states of items) which are used in a high-level planner of the example;

FIG. 18 is a view for illustrating a list of definitions of predicates (predicates indicative of classifications of the items) which are used in the high-level planner of the example;

FIG. 19 is a view for illustrating a list of definitions of predicates (predicates indicative of how to use the items) which are used in the high-level planner of the example;

FIG. 20 is a view for illustrating an example of world knowledge in background knowledge used in the example;

FIG. 21 is a view for illustrating an example of a crafting rule in an inference rule used in the example;

FIG. 22 is a view for illustrating an example (trial early phase) of a hypothesis produced by an abduction unit in the example;

FIG. 23 is a view for illustrating an example (trial final phase) of the hypothesis produced by the abduction unit in the example; and

FIG. 24 is a view for illustrating an experimental result (Proposed) by a proposal method of the determination device according to the example embodiment and two experimental results (Baseline-1. Baseline-2) by hierarchical reinforcement teaming methods according to determination devices of related art.

### DESCRIPTION OF EMBODIMENTS

[Related Art]

In order to facilitate an understanding of the present invention, a related art will be described first.

As described above, the abduction is an inference such as to derive the best explanation for a given observation. The abduction receives observation O and background knowledge B and produces the best explanation (solution hypothesis) H*. The observation O is a compound word of literals in the first-order predicate logic. The background knowledge B comprises a set of implication-type logical expressions. The solution hypothesis H* is represented by the following Math. 1:

$${H}^{*} = arg {max}_{H} [ E ( H ) ] ; H ⋃ B \text{\textbar =} O , H ⋃ B \text{\textbar ≠} ⊥ \qquad [ Math . 1 ]$$

In Math. 1, E(H) represents any evaluation function for evaluating a merit of a hypothesis H as an explanation. In addition, an expression of HUB on the right side in Math. 1 represents that the hypothesis H must explain the observation O and must not conflict with the background knowledge B.

As one of abduction models, “Weighted Abduction” as described in the above-mentioned Non-Patent Literature 2 is known. The Weighted Abduction is a de facto standard for narrative understanding by the abduction. The Weighted Abduction generates hypothesis candidates by applying a backward reasoning operation and a unification operation. The Weighted Abduction uses, as the evaluation function E(H), the following Math. 2:

$$E ( H ) = - {\sum }_{p ∈ H} cost ( p ) \qquad [ Math . 2 ]$$

The evaluation function E(H) in Math. 2 represents that the hypothesis candidate having a smaller total sum of overall cost is better explanation.

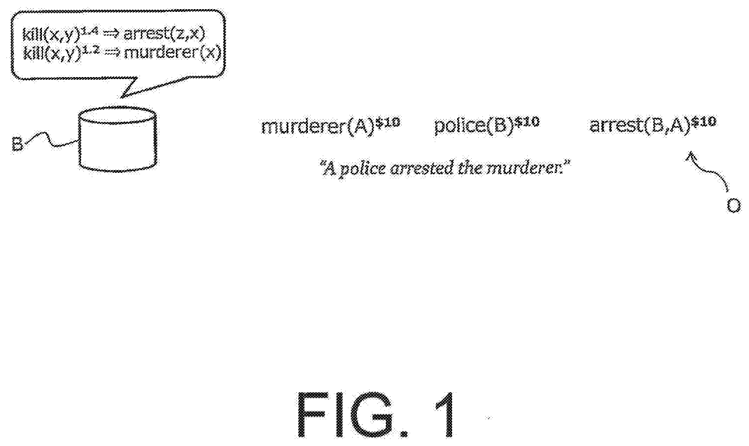

FIG. 1 is a view for illustrating an example of narrative, observation O, and a rule of the background knowledge B. In this example, the narrative is “A police arrested the murder.” In this event, the observation O includes murder (A), police (B), and arrest (B, A). As shown in FIG. 1, the observation O is assigned with a cost (in this example, $10) at a right shoulder thereof. In this example, as the rule of the background knowledge B, there are a first rule of “kill (x, y)→arrest (z, x)” and a second rule of “kill (x, v)→murder (x)”. That is, the first rule is that “z arrests x because x killed y” whereas the second rule is that “x is the murder because x killed y”. As shown in FIG. 1, each rule of the background knowledge B is assigned with a weight at a right shoulder thereof. The weight represents reliability and indicates that the higher the weight is, the lower the reliability is. In this example, the first rule is assigned with the weight of “1.4” whereas the second rule is assigned with the weight of “1.2”.

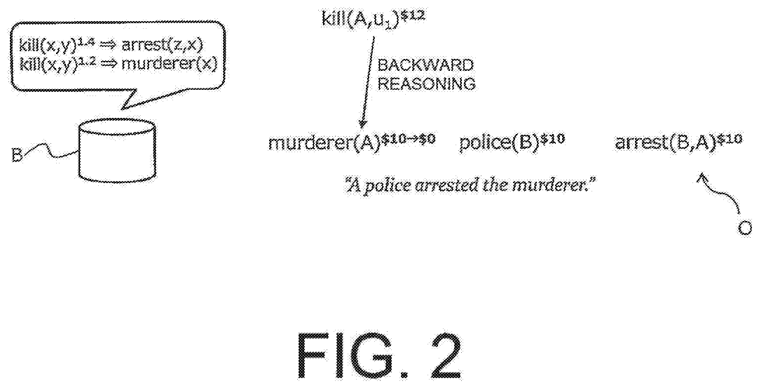

In a case of the example of FIG. 1, first, as illustrated in FIG. 2, the second rule is traced back in the opposite direction to build up a hypothesis. The hypothesis in this case is that “the murder A killed a person u₁” via backward reasoning. The reason of the inference has a cost which propagates to the hypothesis entirely. The hypothesis has a cost which is obtained by multiplying the cost of the reason of the inference by the weight of the second rule.

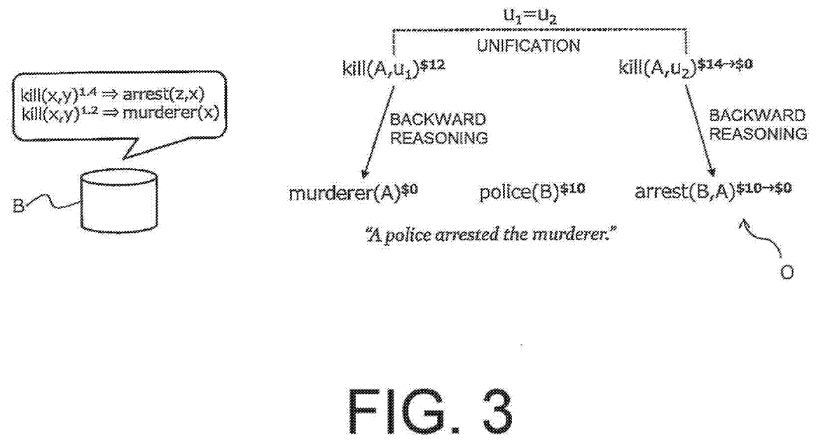

For the case of the example of FIG. 1, further from a state of FIG. 2, the first rule is traced back in the opposite direction to build up a hypothesis in the similar manner, as illustrated in FIG. 3. The hypothesis in this case is that “A police B arrested the murder A because he/her killed a person u₂” via backward reasoning, in this case also, the reason of the inference has a cost which propagates to the hypothesis entirely. The hypothesis has a cost which is obtained by multiplying the cost of the reason of the inference by the weight of the first rule. Then, it is hypothesized that a pair of literals having the same predicate (in this example, “kill”) are identical to each other. In this case, it is hypothesized that the killed person is the same person (u₁=u₂). When unification is performed in this way, the higher cost is cancelled.

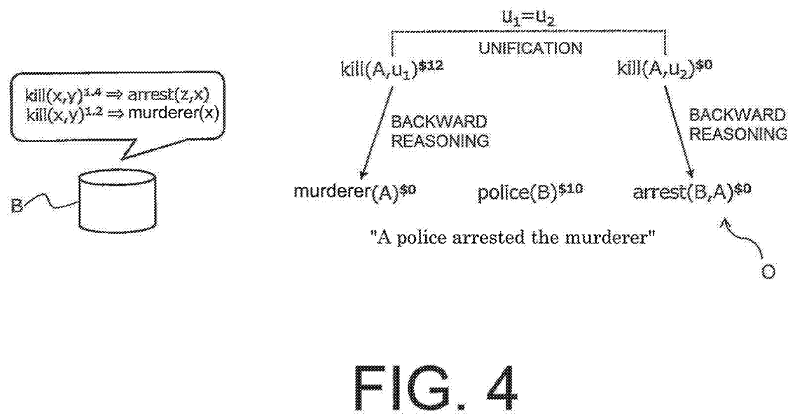

Finally, as illustrated in FIG. 4, it is inferred that “The police B arrested the murder A because the murder A killed the person (u₁=u₂)”. In this case, the hypothesis has a cost given by $10+$12 $22.

Next, as an example of “how to resolve the problem using abduction”, a planning task will be explained by way of example. In the planning task, modeling is possible in a natural form by giving a current state and a final state as observations.

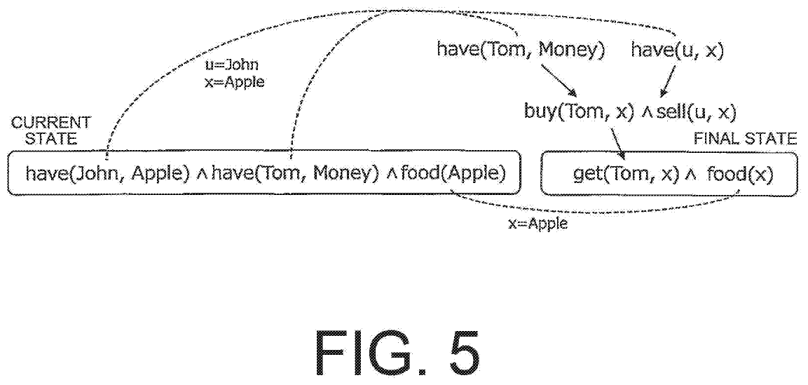

FIG. 5 is a view for illustrating an example which is obtained by modeling from the current state and the final state in the planning task.

In the example of the planning task in FIG. 5, the current state is “have (John, Apple)”, “have (Torn, Money)”, and “food (Apple)”. That is, the current state is that “John has an Apple.”, “Torn has Money.”, and “the Apple is food.”

In the example of the planning task in FIG. 5, the final state is “get (Tom, x)” and “food (x)”. That is, the final state is that “Torn wants any food.”

In the example of the planning task in FIG. 5, the following modeling is possible. Specifically, it is possible to infer, from the current state of “have (Tom, Money)”, that “TOM can buy anything if he has money”. That is, “buy (Tom, x)”. In addition, it is possible to infer, from the current state of “have (John, Apple)”, that “if having something, it is possible to sell that something”. This is because, assuming u=Jone and x=Apple, “have (u, x) is given. That is, “sell (u, x)”. From the inference of “buy (Tom, x)” and the inference of “sell (u, x)”, it is possible to infer that “If he/her buys something from somebody, he/her obtains that something”. From this inference, x=Apple is derived. It is therefore possible to derive an action of “buy Apple from Jone” as planning for arriving at a goal state.

Next, reinforcement learning will be described. As described above, the reinforcement learning is a kind of machine learning for dealing with a problem in which an agent in an environment observes a current state of the environment and determines actions to be carried out.

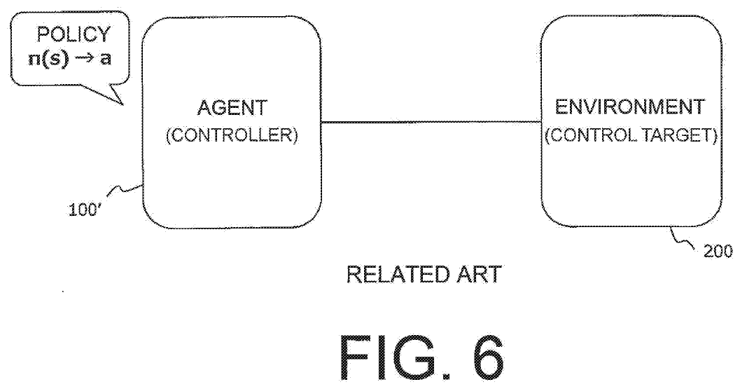

FIG. 6 is a block diagram for illustrating a reinforcement learning system including a determination device of a related art for implementing the reinforcement learning. The reinforcement learning system comprises an environment 200 and an agent 100′. The environment 200 is also called a controlled target or a target system. On the other hand, the agent 100′ is also called a controller. The agent 100′ acts as the determination device of the related art.

First, the agent 100′ observes a current state of the environment 200. That is, the agent 100′ acquires a state observation Sₜ from the environment 200. Subsequently, the agent 100′ selects an action aₜ to obtain, from the environment 200, a reward r₁ corresponding to the action aₜ. In the reinforcement learning, a Policy π(s) for the action a is learned (π(s)→a) such that the reward rt obtained through a series of actions at of the agent 100′ becomes the maximum.

In the determination device of the related art, the best operation procedure is not calculated in a realistic time because the target system 200 is complicated. If there is a simulator or a virtual environment, it is also possible to employ a trial-and-error approach by the reinforcement learning. However, in the determination device of the related art, search in the realistic time is impossible because a search space is huge.

In addition, in the determination device of the related art, even if a procedure (planning result) found by the reinforcement learning is indicated, it is difficult for a human being to understand the procedure (planning result). This is because a degree of abstraction which the human being can understand and a degree of abstraction of the system operation are different from each other.

In order to resolve such problems, a hierarchical reinforcement learning method, Which is disclosed in the above-mentioned Non-Patent Literature 1, has been proposed. The hierarchical reinforcement learning method performs planning by dividing into at least one layer which comprises the degree of abstraction (high level) which the human being can understand and a specific operation procedure (low level) of the target system 200. In the hierarchical reinforcement learning method, a model for limiting the search space is called a high-level planner whereas a reinforcement learning model for performing the learning in the search space presented by the high-level planner is called a low-level planner.

A situation is supposed in which knowledge related to the environment 200 is preliminarily given as an inference rule and policy for making the environment (target system) 200 reach a target state from a starting state is learned using the reinforcement learning. In this event, as described above, in Non-Patent Literature 1, the high-level planner at first enumerates by inference, using the Answer Set Programming and the inference rule, a set of intermediate states through which the environment (target system) 200 possibly passes on the way from the starting state to the target state. The respective intermediate states are called subgoals. In consideration of a group of subgoals presented by the high-level planner, the low-level planner learns the policy such that the environment (target system) 200 reaches the target state from the starting state.

However, as described above, in the technique disclosed in Non-Patent Literature 1, there is a problem that it is impossible to give an appropriate subgoal in the environment 200 for which all of observations are not given.

In addition, as described above, Non-Patent Literature 2 discloses one example of abduction methods using the computer. In Non-Patent Literature 2 also, the above-mentioned Answer Set Programming is used as the logical deductive inference model. As described above, in the Answer Set Programming, it is impossible to suppose the entity, which is not observed, in the middle of inference as necessary.

It is an object of the present invention to provide a determination device which is capable of resolving the above-mentioned problem.

### Overview of Invention

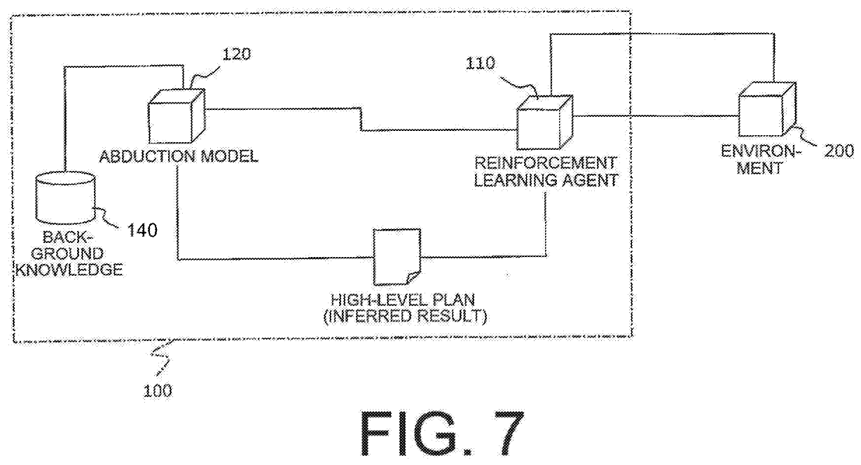

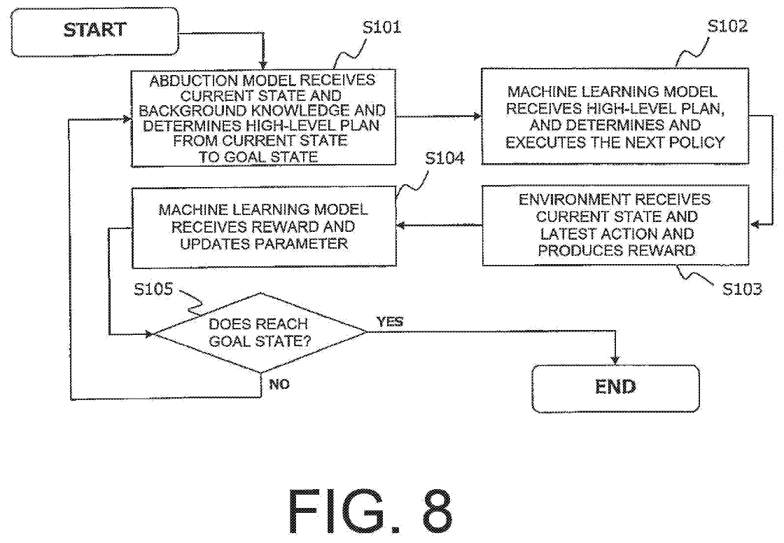

Next, referring to the drawings, an overview of the present invention will be described. FIG. 7 is a block diagram for illustrating a hierarchical reinforcement learning system including a determination device 100, which illustrates the overview of the present invention. FIG. 8 is a flow chart for use in describing an operation of the hierarchical reinforcement learning system illustrated in FIG. 7.

As shown in FIG. 7, the hierarchical reinforcement learning system comprises the determination device 100 and the environment 200. The environment 200 is also called the controlled target or the target system. The determination device 100 is also called the controller.

The determination device 100 comprises a reinforcement learning agent 110, an abduction model 120, and background knowledge (background knowledge information) 140. The reinforcement learning agent 110 serves as a low-level planner. The reinforcement learning agent 110 is also called a machine learning model. The abduction model 120 serves as a high-level planner. The background knowledge 140 is also called a knowledge base (knowledge base information).

The abduction model 120 receives a state of the reinforcement learning agent 120 as an observation and infers an “action to be performed in order to maximize a reward” at an abstraction level. The “action to be performed in order to maximize a reward” is also called a subgoal or an intermediate state. The abduction model 120 uses the background knowledge 140 upon inference. The abduction model 120 produces a high-level plan (inferred result).

On the other hand, the reinforcement learning agent 110 takes an action on the environment 200 and obtains the reward from the environment 200. The reinforcement learning agent 110 learns, through the reinforcement learning, a series of operations for achieving the subgoal given from the abduction model 120. In this event, the reinforcement learning agent 110 uses the high-level plan (inferred result) as the subgoal.

Next, referring to FIG. 8, description will be made as regards an operation of the hierarchical reinforcement learning system illustrated in FIG. 7.

First, the abduction model 120 receives a current state of the environment 200 and the background knowledge 140 and determines a high-level plan from the current state up to a goal state (Step S101). The goal state is also called a target state or a goal. In other words, the reinforcement learning agent 110 supplies the abduction model 120 with the current state of the reinforcement learning agent 110 as the observation. The abduction model 120 performs inference using the background knowledge 140 to produce the high-level plan.

Subsequently, the machine learning model, which is the reinforcement learning agent 110, receives the high-level plan as the subgoal to determine and execute the next policy (Step S102). In response thereto, the environment 200 receives the current state and the latest action to produce a reward value (Step S103), That is, the reinforcement learning agent 110 performs the action towards the latest subgoal. In this event, in the high-level plan, for example, an action farthest from the goal becomes the subgoal. As the subgoal, basically, movement from the current state to a designate position alone is indicated.

Next, the machine learning model, which is the reinforcement learning agent 110, receives the reward value to update a parameter (Step S104). Then, the abduction model 120 judges whether or not the environment 200 reaches the goal state (Step S105). If the environment does not reach the goal state (No in the Step S105), the determination device 100 returns the processing to the Step S101. That is, if the subgoal is reached, the determination device 100 returns to the Step S101. Accordingly, the abduction model 120 uses, as the observation, the state after reaching the subgoal and creates a high-level plan again.

On the other hand, if the goal state is reached (YES in the Step S105), the determination device 100 ends the processing. That is, if an end condition is satisfied, the determination device 100 ends the processing. Herein, as the end condition, for instance, arrival at any goal or a game becoming over is supposed in a case where a computer game is a learning target.

Next, effects of the determination device 100 will be described.

First, since the hierarchical enforcement learning method is employed, it is possible to give an appropriate subgoal and to make the reinforcement learning more efficient.

Next, since the logical inference model 120 is used as the high-level planner, there are the following effects.

Firstly, it is possible to use the symbolic prior knowledge 140. Accordingly, interpretability of the knowledge itself is high and maintenance is easy. In addition, a “document for a human being” such as a manual can be reused in a natural form.

Secondly, it is possible to function even in a situation where the amount of data used for learning is small. However, it is necessary to give the prior knowledge 140 in correspondence thereto. Accordingly, it is useful in a case where learning data is small in amount although the manual is rich in content.

Thirdly, it is possible to carry out higher-level decision making in comparison with a statistical method. Specifically, even a concept which is difficult to learn from a simple trial and error, such as a mutual relationship latently present between observation information, can be dealt with naturally if logical inference is used.

In addition, since the abduction is used in the high-level planner, there are the following effects.

Firstly, the interpretability of an output is high. This is because the inferred result (high-level plan) is not a simple conjunction of logical expression but is obtained in a form of a proof tree having a structure. It is therefore possible to present, in the natural form, What inference leads to the result.

Secondly, it is possible to introduce a free variable into the inference. It is therefore possible to freely suppose a variable which is not included in the observation. In addition, even in a situation where the observation is insufficient, it is possible to generate an entire plan while building up a hypothesis appropriately. This makes it possible to parallelize the learning. Furthermore, there is an advantage that whether the target task is a MDP (Markov Decision Process) or a POMDP (Partially Observable Markov Decision Process) is not depended on.

Thirdly, it is possible to flexibly define an evaluation function. More in detail, the evaluation function for the abduction is not based on a specific theory (probability theory and so on). As a result, it is possible to freely define a criterion of a “merit of hypothesis” in accordance with the task. Different from a stochastic inference model, it is possible to naturally apply even in a case where an element except for “feasibility of a plan” is involved in evaluation of the merit of the plan. A specific example of the evaluation function will later be described.

Example embodiments will hereinafter be described in detail with reference to the drawings.

### First Example Embodiment

[Explanation of Configuration]

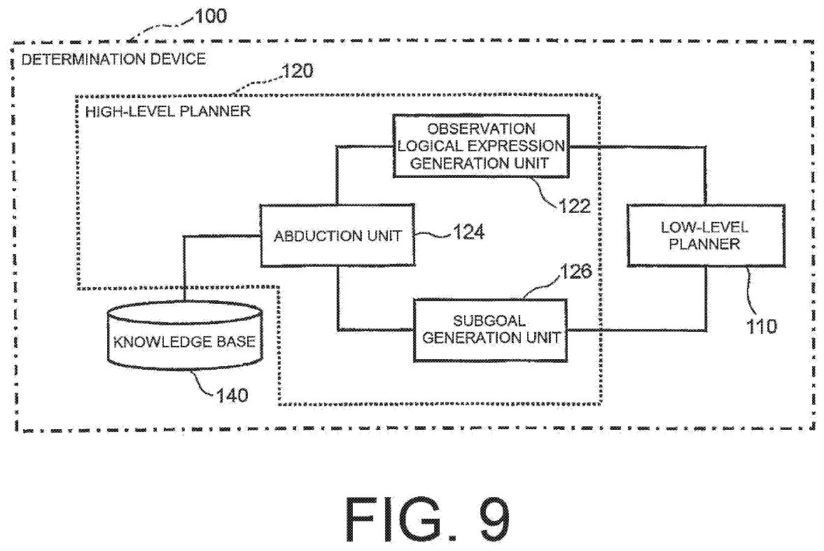

Referring to FIG. 9, the determination device 100 according to a first example embodiment of the present invention comprises the low-level planner 110 and the high-level planner 120. The high-level planner 120 comprises an observation logical expression generation unit 122, an abduction unit 124, and a subgoal generation unit 126. The abduction unit 124 is connected to the knowledge base 140. All of these components may be implemented by processing executed by a microcomputer which is mainly composed of an input/output device, a storage device, a CPU (central processing unit), and a RAM (random access memory) although not shown in the figure.

The high-level planner 120 produces a plurality of subgoals SG through which the low-level planner 110 should pass in order to reach a target state St. The low-level planner 110 determines actual actions in accordance with the subgoals SG.

The target system (environment) 200 (see FIG. 7) is related to a plurality of states. Herein, information indicative of a certain state among the plurality of states is called “first information” whereas information indicative of a target state related to the target system (environment) 200 is called “second information”. Among the plurality of states, those states except for a starting state and the target state are called intermediate states. As described above, each intermediate state is called the subgoal whereas the target state is called the goal.

Accordingly, in other words, the low-level planner 110 determines, based on state-related rewards in the above-mentioned plurality of states, actions from the above-mentioned certain state up to the above-mentioned intermediate state calculated.

The observation logical expression generation unit 122 converts the above-mentioned target state, a current state of the low-level planner 110 itself, and the first information indicative of the certain state related to the environment 200 and observable by the low-level planner 110 into a conjunction of a first-order predicate logical expression, namely, an observation logical expression Lo. Herein, it is assumed that the hypothesis includes a plurality of logical expressions which indicate a relationship between the above-mentioned first information and the above-mentioned second information. In this event, the observation logical expression Lo is selected from the above-mentioned plurality of logical expressions, A conversion method at this time may be defined by a user in accordance with a system as an application target.

The abduction unit 124 is an abduction model based on the first-order predicate logic as shown in the above-mentioned Non-Patent Literature 2. The abduction unit 124 receives the knowledge base 140 and the observation logical expression Lo and produces the above-mentioned hypothesis Hs which is the best one as explanation for the observation logical expression Lo. The evaluation function used at this time may be defined by the user in accordance with the system as the application target. The evaluation function is a function for defining a predetermined hypothesis working procedure.

Accordingly, a combination of the above-mentioned observation logical expression generation unit 122 and the above-mentioned abduction unit 124 serves as a hypothesis preparation unit (122; 124) configured to prepare, in accordance with the predetermined hypothesis preparation procedure, the hypothesis Hs including the plurality of logical expressions indicating the relationship between the first information and the second information.

The subgoal generation unit 126 receives the hypothesis Hs produced by the abduction unit 124 and produces the plurality of subgoals SG through which the low-level planner 100 should pass in order to reach the target state St. A conversion method (predetermined conversion procedure) at this time may be defined by the user in accordance with the system as the application target. Accordingly, the subgoal generation unit 126 serves as a conversion unit configured to calculate, in accordance with the predetermined conversion procedure, an intermediate state (subgoal) indicated by a logical expression, among the plurality of logical expressions included in the hypothesis Hs, that is different from a logical expression related to the first information.

### Explanation of Operation

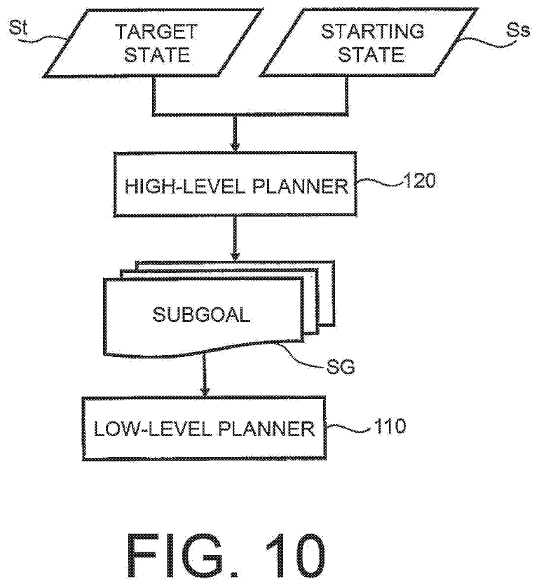

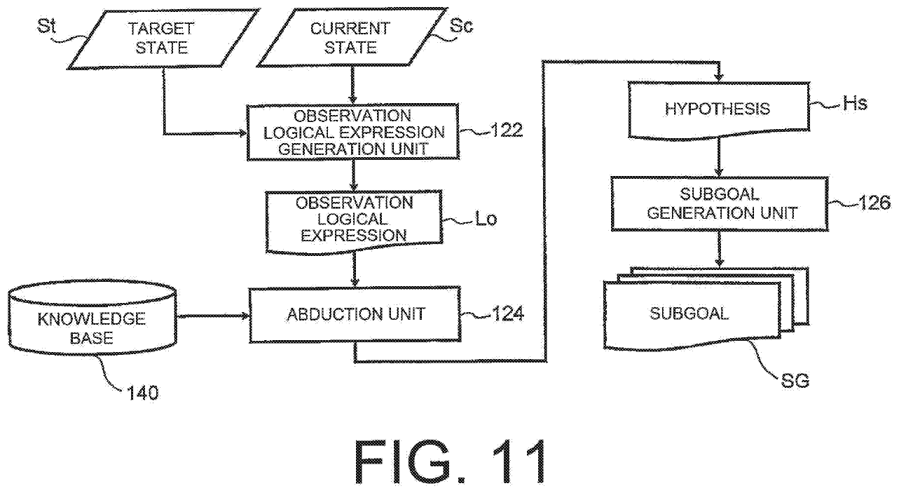

Next, referring to flow charts of FIGS. 10 and 11, description will proceed to an operation of the entire determination device 100 according to the example embodiment.

First, FIG. 10 represents a flow, until the plurality of subgoals SG required to reach the target state St from the starting state Ss are given by the high-level planner 120 to the low-level planner 110 when the starting state Ss and the target state St are given.

FIG. 11 represents a flow chart for deriving, by the high-level planner 110, the plurality of subgoals SG required to reach the target state St from the current state Sc. At the start of trial, the current state Sc is identical to the starting state Ss.

The observation logical expression generation unit 122 converts the starting state Ss and the target state St into first-order predicate logical expressions, respectively. A combination of these logical expressions as the conjunction is treated as the observation logical expression Lo.

Next, the abduction unit 124 receives the observation logical expression Lo and the knowledge base 140 and produces the hypothesis Hs. In this event, when the current state Sc and arrival at the target state St at a particular time instant in future are previously determined, respectively, inference performed by the abduction unit 124 is intuitively equivalent to making an explanation therebetween. The knowledge base 140 comprises a set of inference rules which represent prior knowledge related to the environment (target system) 20 with the first-order predicate logical expressions.

Next, the subgoal generation unit 126 receives the hypothesis Hs and generates a group of the subgoals SG to be passed in order to reach the target state St from the starting state Ss. In this event, if an order relationship is present between the individual subgoals SG, output may be made in a format in consideration thereof.

The low-level planner 110 selects an action so as to reach the presented group of the subgoals SG and learns a policy in accordance with the reward obtained from the environment (target system) 20. In this event, basically, in a manner similar to the existing hierarchical reinforcement learning, the learning is controlled by giving an internal reward every time when the low-level planner 110 reaches every subgoal SG.

### Explanation of Effect

Next, an effect of the first example embodiment will be described.

The first example embodiment uses, as the high-level planner 120, the abduction model based on the first-order predicate logic. It is therefore possible, by using the abduction model 120, to generate a series of subgoals SG required to reach the target state St from the starting state Ss while building up the hypothesis as necessary, even in an environment with insufficient observation. Accordingly, the low-level planner 110 can efficiently learn the policy to reach the target state St by selecting the action so as to pass through the series of subgoals SG. In addition, the reward obtained by executing the plan can be taken into account in evaluation of the hypothesis.

Each part of the determination device 100 may be implemented by a combination of hardware and software. In a form in which the hardware and the software are combined, the respective parts are implemented as various kinds of means by developing a determination program in a RAM and making hardware such as a control unit (CPU) operate based on the determination program. The determination program may be recorded in a recording medium to be distributed. The determination program recorded in the recording medium is read into a memory via a wire, wirelessly, or via the recording medium itself to operate the control unit and so on. By way of example, the recording medium may be an optical disc, a magnetic disk, a semiconductor memory device, a hard disk, or the like.

Explaining the above-mentioned first example embodiment with a different expression, it is possible to implement the first example embodiment h making a computer to be operated as the determination device 100 act as the low-level planner 110 and the high-level planner 120 (observation logical expression generation unit 122, the abduction unit 124, and subgoal generation unit 126) according to the determination program developed in the RAM.

### Second Example Embodiment

[Explanation of Configuration]

Next, a determination device 100A according to a second example embodiment of the present invention will be described in detail with reference to the drawing.

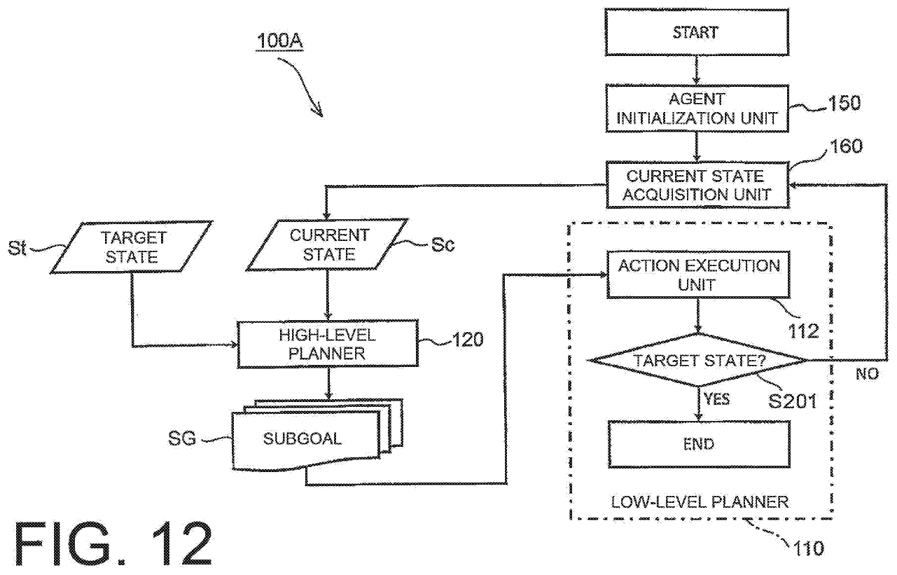

FIG. 12 represents a flow of the determination device 100A until the low-level planner 110 reaches the target state St from the starting state Ss in a certain one trial of the reinforcement learning when the starting state Ss and the target state St are given.

The illustrated determination device 110A further comprises an agent initialization unit 150 and a current state acquisition unit 160 in addition to the low-level planner 110 and the high-level planner 120. The low-level planner 110 includes an action execution unit 112.

The agent initialization unit 150 initializes a state of the low-level planner 110 into the starting state Ss.

The current state acquisition unit 160 extracts the current state Sc of the low-level planner 110 as an input of the high-level planner 120 (observation logical expression generation unit 122).

The action execution unit 112 determines and executes the action according to the intermediate state (subgoal SG) presented by the subgoal generation unit (conversion unit) 126 and receives the reward from the environment (target system) 20.

[Explanation of Operation]

These means roughly operate in the following manner, respectively.

First, the agent initialization unit 150 initializes the state of the low-level planner 110 into the starting state Ss.

Next, the current state acquisition unit 160 acquires the current state Se of the low-level planner 110 and supplies the current state Sc to the high-level planner 120. At the start of trial, the current state Sc is identical to the starting state Ss.

Next, the high-level planner 120 produces the series of subgoals SG required to reach the target state St from the current state Sc.

Next, the action execution unit 112 of the low-level planner 110 determines and executes the action in accordance with the subgoal SG presented by the high-level planner 120 and receives the reward from the environment.

Finally, the low-level planner 110 judges whether or not the current state Sc reaches the target state St (Step S201). When the current state Sc reaches the target state St (YES in the Step S201), the low-level planner 110 ends the trial. When the current state Sc does not reach the target state St (NO in the Step S201), the determination device 110A loops the processing to the current state acquisition unit 160. Then, the high-level planner 120 again calculates the series of subgoals SG required to reach the target state St from the current state Sc.

[Explanation of Effect]

Next, an effect of the second example embodiment will be described.

The second example embodiment is configured so that, every time when the low-level planner 120 executes the action, the subgoals SG are recalculated. Therefore, even in a case where new information is observed in the middle of the trial and consequently the best plan changes, it is possible to select the action based on the best subgoal SG at each time instant. Each part of the determination device 100A may be implemented by a combination of hardware and software. In a form in which the hardware and the software are combined, the respective parts are implemented as various kinds of means by developing a determination program in a RAM and making hardware such as a control unit (CPU) operate based on the determination program. The determination program may be recorded in a recording medium to be distributed. The determination program recorded in the recording medium is read into a memory via a wire, wirelessly, or via the recording medium itself to operate the control unit and so on. By way of example, the recording medium may be an optical disc, a magnetic disk, a semiconductor memory device, a hard disk, or the like.

Explaining the above-mentioned second example embodiment with a different expression, it is possible to implement the second example embodiment by making a computer to be operated as the determination device 100A act as the low-level planner 110 (action execution unit 112), the high-level planner 120, the agent initialization unit 150, and the current state acquisition unit 160 according to the determination program developed in the RAM.

### Third Example Embodiment

[Explanation of Configuration]

Next, a determination device 110B according to a third example embodiment of the present invention will be described in detail with reference to the drawing.

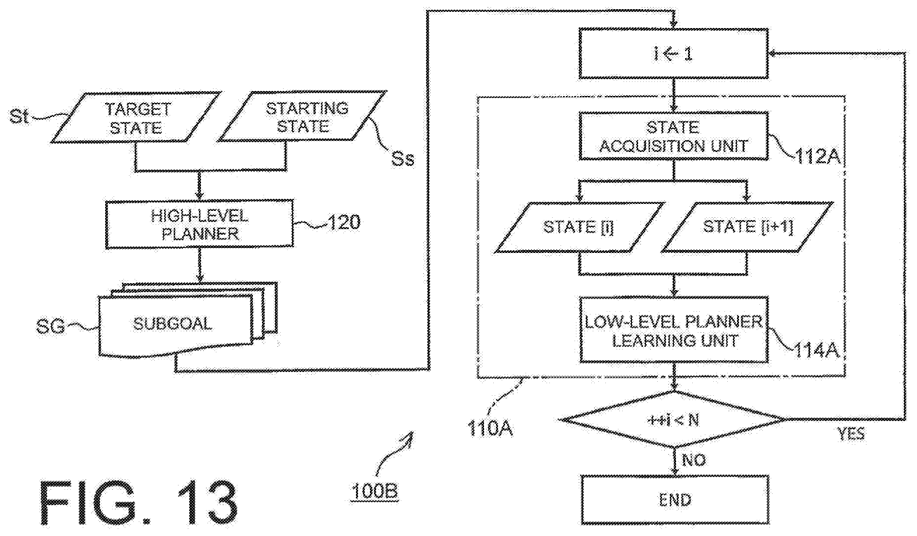

FIG. 13 is a flow chart in a case where the learning of a low-level planner 110A in the determination device 110B is executed in parallel. The low-level planner 110A comprises a state acquisition unit 112A and a low-level planner learning unit 114A. Herein, as a premise, it is assumed that the subgoals SG produced by the high-level planner 120 are arranged in an array in which the subgoals are sorted in an order to be passed through and the number of elements is equal to N. In addition, it is assumed that the leading element of the array is the starting state Ss whereas a final element of the array is the target state St.

The state acquisition unit 112A receives an index value i and the series of subgoals SG and acquires an i-th subgoal SGᵢ and an (i+1)-th subgoal SQᵢ₊₁, respectively. Herein, the acquired agent states are represented as a state [i] and a state [i+1], respectively.

The low-level planner learning unit 114A learns the policy of the low-level planner 110A in parallel, using the state as the starting state Ss and the state [i+1] as the target state St.

[Explanation of Operation]

These means roughly operate in the following manner, respectively.

First, the high-level planner 120 receives the starting state Ss and the target state St and produces, as an array along a time series, the series of the subgoals SG required to reach the target state St from the starting state Ss.

Next, the low-level planner 110A executes the learning of the low-level planner 110A for respective adjacent element pairs in the series of subgoals SG. Specifically, the state acquisition unit 112A acquires the subgoal pair SGᵢ and SGᵢ₊₁ as a target. Next, the low-level planner learning unit 114A considers them as the starting state Ss and the target state St and executes the learning of the low-level planner 110A.

### Explanation of Effect

Next, an effect of the third example embodiment will be described.

In the third example embodiment, the learning of each of the policies between the respective subgoals SG is independently carried out. Therefore, a time required in the learning can be reduced by executing the respective learning in parallel.

Each part of the determination device 100B may be implemented by a combination of hardware and software. In a form in which the hardware and the software are combined, the respective parts are implemented as various kinds of means by developing a determination program in a RAM and making hardware such as a control unit (CPU) operate based on the determination program. The determination program may be recorded in a recording medium to be distributed. The determination program recorded in the recording medium is read into a memory via a wire, wirelessly, or via the recording medium itself to operate the control unit and so on. By way of example, the recording medium may be an optical disc, a magnetic disk, a semiconductor memory device, a hard disk, or the like.

Explaining the above-mentioned third example embodiment with a different expression, it is possible to implement the third example embodiment by making a computer to be operated as the determination device 100B act as the low-level planner 110A (the state acquisition unit 112A and the low-level planner learning unit 114A) and the high-level planner 120 according to the determination program developed in the RAM.

### Example

Next, description will proceed to an example in a case where the determination device 100 according to the first example embodiment of the present invention is applied to a specific target system 20. The target system 20 in this example comprises a toy task. The toy task is a craft game imitating a Minecraft (registered trademark). That is, the toy task is a task of gathering and crafting materials in a field and crafting an item to be a target.

Hereinafter, description will proceed to a mission definition in the toy task according to this example. The starting state Ss is a state of being present at a particular coordinate (depicted by S) on a map, having no item, and having no information with respect to the field. The target state St is to reach a certain coordinate (depicted by G) on the map. However, if some coordinates (depicted by X) present on the field are passed, this results in a failure at that time instant. If stated otherwise in connection with a plant operation or the like, this corresponds to a situation where explosion occurs if an operation is not carried out in accordance with an appropriate procedure.

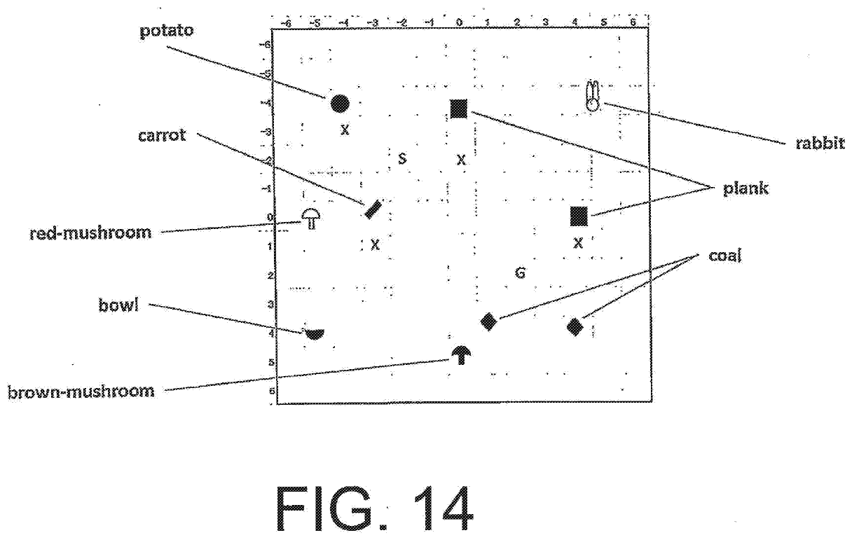

The field is a two-dimensional space with 13×13 squares, in which various items are arranged. FIG. 14 illustrates an example of arrangement of the items.

The illustrated toy task comprises a task of gathering items falling on the map to produce food. The arrangement of the items is fixed and the map has a size of 13×13 as described above.

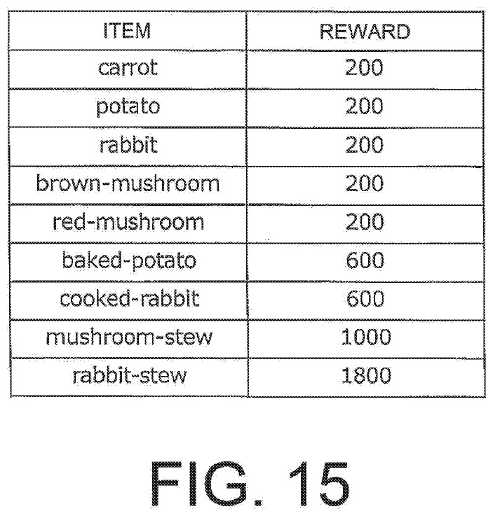

At a time instant of returning to a starring point (S) with the food possessed, a reward corresponding to the possessed food is given. For one of the possessed items that would provide the largest reward, the reward is given. FIG. 15 illustrates an example of a reward table.

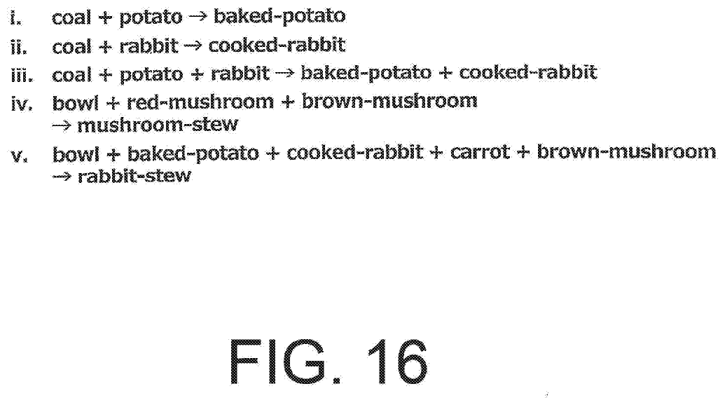

An action which the agent can take is only to move in any of four directions of north, south, east and west. Crafting of the item is automatically carried out at a time instant when materials are gathered. Different from the original game, it is assumed that no crafting table is necessary. FIG. 16 illustrates an example of crafting rules. Among these crafting rules, for example, a third rule “iii.” indicates that “if both of poteto and rabbit are possessed, the both can be cooked with one coal”. Since getting and/or crafting of the items is automatically carried out, “when and what to make” results in a problem “at which timing and to which item's position to move”. At a time instant when 100 times of actions are performed or the reward is obtained at the starting point, processing comes to an end.

It is assumed that the agent can perceive presence or absence of items in a range of two squares around him/herself. Whether or not the agent perceives a position of each item is represented as a state of the agent.

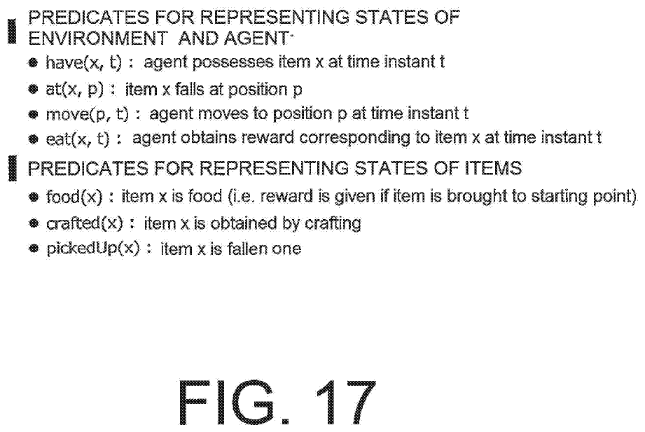

The knowledge base 140 in this task is constructed of inference rules in which rules related to the craft, common-sense rules and the like are represented by first-order predicate logical expressions. In order to deal with by the abduction model 120, it is necessary to express various states with logical representations. FIGS. 17, 18, and 19 illustrate lists of predicates which are defined in the logical representation of this example.

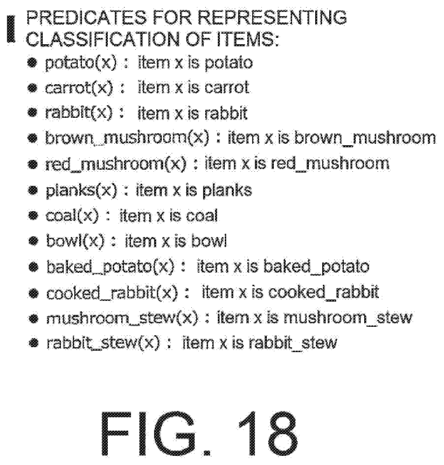

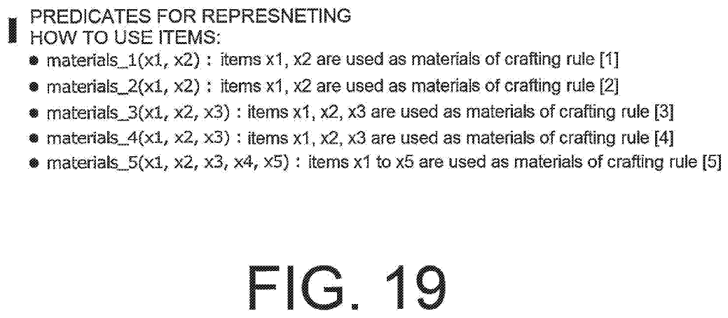

FIG. 17 is a view of the list which indicates definitions of the predicates for representing states of the environment and/or the agent and definitions of the predicates for representing states of the items. FIG. 18 is a view of the list which indicates definitions of the predicates for representing classifications of the items. FIG. 19 is a view of the list which indicates definitions of the predicates for representing how to use the items.

In this example, a current state and a final goal represented by the logical representation are used as observation. The current state is what the agent has, what falls on the map and where it falls, and so on. For instance, the logical representation in a case where the agent has a carrot is carrot(X1)∧have(X1, Now). For instance, the logical representation in a case where coal falls at a coordinate (4, 4) is coal(X2)∧at(X2, P_4_4). As the final goal, for instance, the logical expression is eat (something, Future) in a case where the agent obtains the reward corresponding to some food “something” at a certain future time instant.

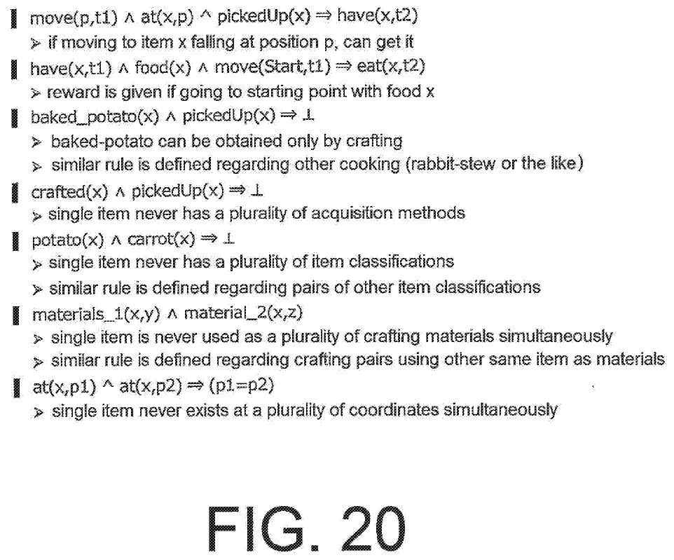

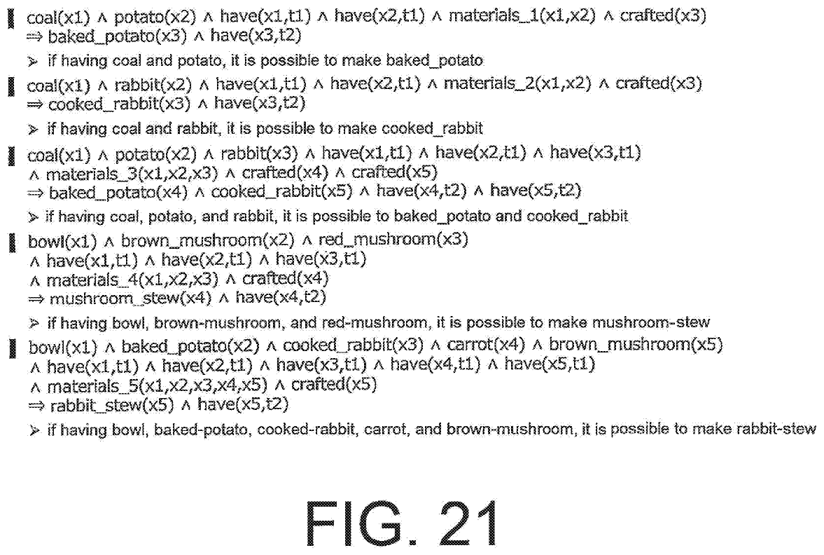

In addition, in this example, those manually prepared are used as the knowledge base 140. The “background knowledge” is information of knowledge which is used in order to resolve the task. In the background knowledge, “world knowledge” is information of knowledge (knowledge related to the world) which relates to a principle and a law in the task in question. The “inference rules” represent individual background knowledge in the form of the logical representation. The “knowledge base” is a set of the inference rules. FIG. 20 is description of the world knowledge of the background knowledge used in this task whereas FIG. 21 is description of crafting rules in the inference rules used in this task.

Next, an evaluation function of the abduction model used in this example will be described as compared with an evaluation function of an abduction model of a related art.

First, description will proceed to the evaluation function of the abduction model of the related art. The evaluation function in the abduction model of the related art is a function for evaluating a “merit as explanation”, in such an evaluation function, it is impossible to evaluate a “merit as hypothesis” on the basis of an evaluation index, which is different from the “merit as explanation”, such as efficiency of a generated plan or the like. Accordingly, the height of the reward obtained by the generated plan cannot be taken into consideration in the evaluation function.

In comparison with this, in this example, the evaluation function of the abduction model is expanded so as to evaluate the merit of the hypothesis as a plan. The following Math. 3 is an expression representing the evaluation function E(H) used in this example.

E(H)=Eₑ(H)+λEᵣ(H) [Math. 3]

Eₑ(H) on the right side of Math. 3 is a first evaluation function for evaluating the merit of the hypothesis H as the explanation regarding the observation. The first evaluation function is identical to the evaluation function of the abduction model of the related art. Eᵣ(H) on the right side of Math. 3 is a second evaluation function for evaluating the merit of the hypothesis as the plan. Furthermore, λ on the right side of Math. 3 is a hyper parameter for carrying out weighting about which one is emphasized.

As will be understood from Math. 3, the evaluation function E(H) used in this example comprises a combination of the first evaluation function E_{c}(H) and the second evaluation function Eᵣ(H).

In this example, the evaluation function E(H) is defined as shown in the following Math. 4.

E(H)=Eₑ(H)+R(H) [Math. 4]

R(H) on the right side of Math. 4 represents a value of the reward obtained when a high-level plan represented by the hypothesis H is performed.

Hereinafter, description will proceed to a flow in which the high-level planner 120 derives the subgoals SG through which the low-level planner 110 reaches the target state St from the current state Sc in this example.

First, in the observation logical expression generation unit 122, the starting state Ss and the current state Sc are converted into the logical expressions, respectively. In this event, the logical expression representing the starting state Ss includes logical expressions representing which item's position the reinforcement learning agent 110 knows, what the reinforcement learning agent 110 has, which coordinate's information the reinforcement learning agent 110 does not have, and so on. In addition, the logical expression representing the target state St is a logical expression representing information that the reinforcement learning agent 110 obtains the reward at the goal position at the certain future time instant.

Next, the abduction unit 124 applies the abduction with these logical expressions used as the observation logical expression Lo. Then, the subgoal generation unit 126 generates the subgoals SG from the hypothesis Hs obtained by the abduction unit 124.

In this task, various kinds of decision making are represented by “when and where to go”. For instance, “by which item the reward is obtained” is represented by “when to return to the starting point”. In addition, for example, “which item to make” is represented by “in which order to move to a coordinate where the item falls”. Therefore, in a system in which only moving destinations are given as the subgoals, this is insufficient because unexpected decision making may be carried out in a moving path. Specifically, in the middle of gathering the materials, the agent passes through the starting point and carelessly arrives at the goal, or the like.

Accordingly, in this example, the subgoal generation unit 126 configures the subgoals to be provided to the reinforcement learning agent 110 with the following elements. Specifically, it is assumed that P is a set (positive subgoals) of coordinates to which it is desired to move next whereas N is a set (negative subgoals) of coordinates to which it is not desired to move.

The reinforcement learning agent 110 learns so as to move to any of the coordinates in P without passing through the coordinates in N. A specific learning method of the reinforcement learning agent 110 will later be described in detail.

Next, description will proceed to extraction of the subgoals in the subgoal generation unit 126.

First, description will proceed to a determination method of the positive subgoals. In this case, the subgoal generation unit 126 considers, as the subgoals, the logical expressions having the predicate “move” in inferred results. Accordingly, the subgoal generation unit 126 gives the reinforcement learning agent 110 a moving destination represented by the logical expression as the subgoal. Herein, in a case where there are a plurality of subgoals, the subgoal generation unit 126 deals with, as the latest subgoal, the subgoal having the farthest distance from the final state of “eat something, Future)”. Herein, the distance means the number of rules to be passed on the proof tree.

Next, description will proceed to a determination method of the negative subgoals. In this case, the subgoal generation unit 126 deals with, as the negative subgoals, all of coordinates which satisfy the following conditions. That is, a first condition is whether the coordinate is the starting point or a coordinate at which any item falls. A second condition is that the coordinate is not included in the positive subgoals.

Next, description will proceed to a specific example of inference which is carried out by the high-level planner 120.

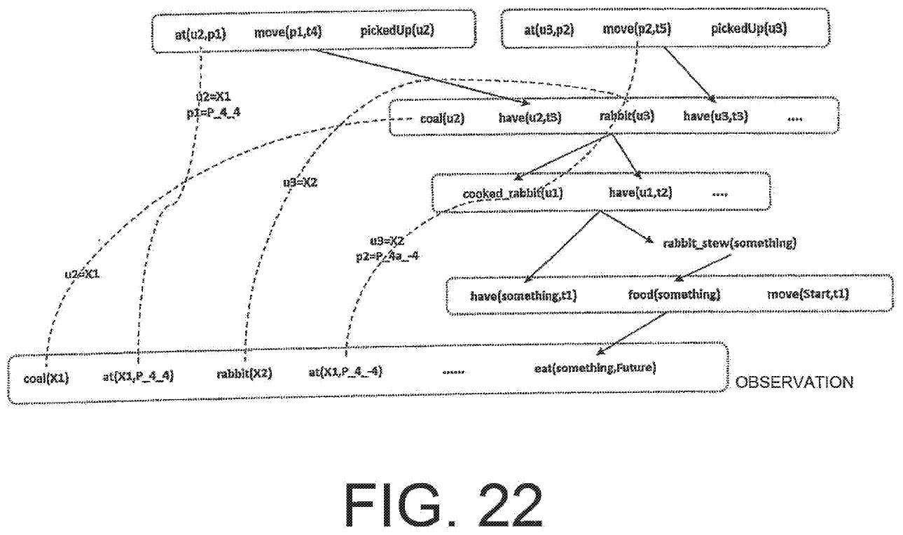

FIG. 22 illustrates a hypothesis Hs which is obtained from the abduction unit 124 in the above-mentioned toy task at a certain time instant in a trial early phase. Arrows of solid lines indicate application of the rules whereas pairs of logical expressions connected by broken lines indicate that those in each pair are logically equivalent to each other in the solution hypothesis Hs. In the figure, logical expressions enclosed by a square at a bottom part are the observation logical expressions Lo. These logical expressions represent that the reinforcement learning agent 110 perceives presence of coal (represented by a variable X1) at a coordinate of 4, 4, and presence of rabbit at a coordinate of 4, −4. The logical expression “eat (something, Future)” is the logical expression indicative of the target state St.

The hypothesis Hs in FIG. 22 is interpreted as follows. First, from observation information that the highest reward is obtained in the future, it is hypothesized that rabbit_stew is possessed at a certain time instant (which is represented by t1) prior thereto. Next, by a rule for crafting the rabbit_stew, it is hypothesized that the reinforcement learning agent 110 obtains cooked_rabbit at a certain time instant (which is represented by t2) before the time instant t1. Furthermore, by a rule for crafting the cooked_rabbit, it is hypothesized that the agent obtains coal and rabbit at a certain time instant (which is represented by t3) before the time instant t2. Finally, assuming that the respective items are found, association is established with knowledge “coal and rabbit fall in the field” owned by the reinforcement learning agent 110 itself.

The subgoal generation unit 126 generates the subgoals SG from this hypothesis Hs. Herein, a case of generating the subgoals SG from the hypothesis Hs of FIG. 22 is considered. On generating the subgoals SG from the hypothesis Hs, various possibilities are conceivable as regards what is supposed to be the subgoals. For instance, it is assumed that, in the subgoal generation unit 126, to move to a specific coordinate is taken as the subgoals. In this case, a series of subgoals such as “to move to a coordinate 4, 4” and “to move to a coordinate 4, −4” are obtained from the hypothesis of FIG. 22.

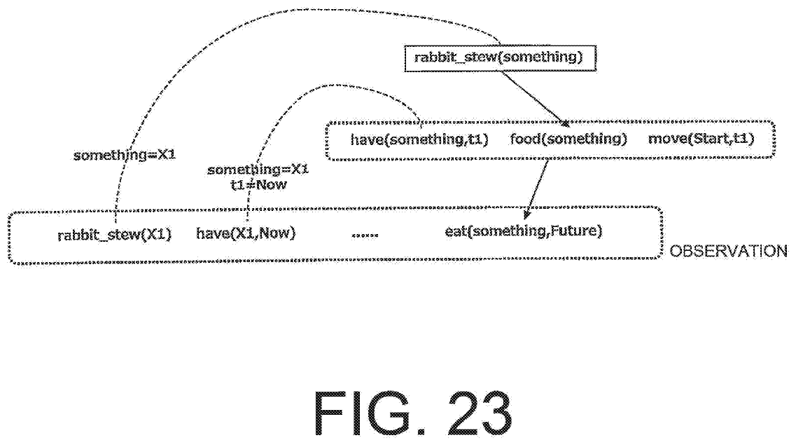

FIG. 23 is the hypothesis Hs which is obtained in the above-mentioned toy task from the abduction unit 124 at a certain time instant in a trial final phase. In the trial final phase, the abduction unit 124 infers that it is only necessary to go to the starting point because the rabbit_stew is obtained. Thus, the subgoal “to move to the goal point” is obtained from the hypothesis Hs of FIG. 23.

On the other hand, it is assumed that classifications of the possessed items are taken as the subgoals SG in the subgoal generation unit 126. In this event, from the hypothesis Hs in FIGS. 22 and 23, a series of subgoals SG “possesses coal”, “possesses rabbit”, “possesses cooked_rabbit”, “possesses rabbit_stew”, and “reaches a goal” are obtained.

Finally, in consideration of the series of subgoals SG thus obtained, the low-level planner (reinforcement learning agent) carries out trial and error and learns the policy.

Next, description will proceed to a specific learning method which is carried out by the reinforcement learning agent 110.

The reinforcement learning agent 110 determines moving directions (four directions of upward, downward, leftward, and rightward). The reinforcement learning agent 110 uses an individual Q function for each subgoal. Learning of the individual Q function is carried out by the SARSA (State, Action, Reward, State (next), Action (next)) method being a general learning method of the reinforcement learning, that is represented by the following Math. 5.

Q(s,a)=Q(s,a)+α[R(s,a)+γ(s′,a′)−Q(s,a)] [Math. 5]

In Math. 5, S represents a state, a represents an action, a represents a learning rate, R represents a reward, γ represents a discount rate of the reward, s′ represents a next-state, and a′ represents a next-action.

Next, description will be made as regards experimental results in a case of experimenting the above-mentioned toy task by the determination device 100 according to the example embodiment of the present invention and in a case of experimenting the above-mentioned toy task by the determination device of the related art.

Other setups of the toy task are as follows. It is assumed that the number of episodes in the reinforcement learning is 100,000. The experiment is carried out five times for each model and an average thereof is treated as an experimental result.

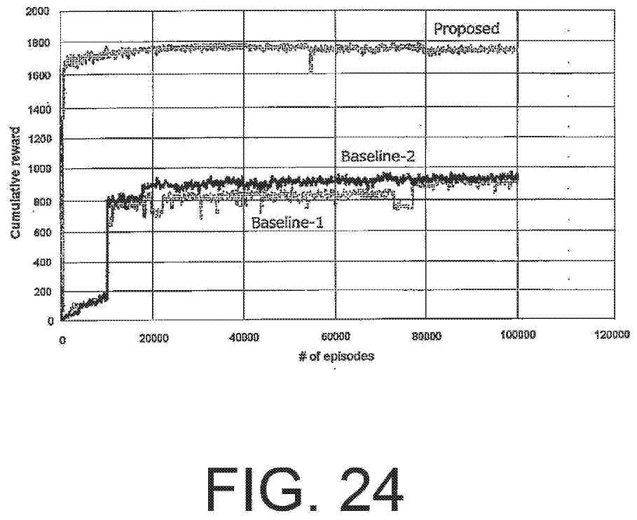

FIG. 24 is a view for illustrating the experimental result (Proposed) by the proposed method of the determination device 100 according to this example embodiment and two experimental results (Baseline-1, Baseline-2) by the hierarchical reinforcement learning method of the determination device of the related art.

The hierarchical reinforcement learning method according to the determination device of the related art learns a Q function for determining subgoals and a Q function for determining actions in accordance with the subgoals, respectively. As regards the subgoals, the following two patterns are used. In Baseline-1, the subgoals are to reach respective areas obtained by dividing the map in FIG. 14 into nine. In Baseline-2, the subgoals are to reach respective coordinates of item positions and a starting point in FIG. 14.

Form FIG. 24, it is confirmed that the proposed method can learn the optimum plan while avoiding a local optimum solution in comparison with the hierarchical reinforcement learning method of the related art. That is, it is understood that the proposed method (Proposed) learns the policy far more efficiently than the methods of the related art (Baseline-1, Baseline-2). In addition, it is understood that the proposed method (Proposed) learns the optimum policy whereas both of the methods of the related art (Baseline-1, Baseline-2) fall into the local optimum.

A specific configuration of the present invention is not limited to the afore-mentioned example embodiment. Any alternations without departing from gist of the present invention are included in the present invention.

While the present invention has been particularly shown and described with reference to the example embodiment (example) thereof, the present invention is not limited to the above-mentioned example embodiment (example). It will be understood by those of ordinary skill in the art that various changes may be made in form and details of the present invention within the scope of the present invention.

The whole or part of the example embodiments described above can be described as, but not limited to, the following supplementary notes.

(Supplementary Note 1)

A determination device, including a hypothesis preparation unit configured to prepare, according to a predetermined hypothesis preparation procedure, a hypothesis including a plurality of logical expressions indicative of a relationship between first information indicative of a certain state among a plurality of states related to a target system and second information indicative of a target state related to the target system; a conversion unit configured to calculate, according to a predetermined conversion procedure, an intermediate state indicated by a logical expression different from a logical expression related to the first information, among the plurality of logical expressions included in the hypothesis; and a low-level planner configured to determine, based on a state-related reward in the plurality of states, actions from the certain state up to the calculated intermediate state.

(Supplementary Note 2)

The determination device according to Supplementary Note 1, wherein the hypothesis preparation unit comprises an observation logical expression generation unit configured to convert the target state and the certain state into an observation logical expression which is selected from the plurality of logical expressions; and an abduction unit configured to infer, based on an evaluation function defining the predetermined hypothesis preparation procedure, the hypothesis from a knowledge base being prior knowledge related to the target system and the observation logical expression.

(Supplementary Note 3)

The determination device according to Supplementary Note 2, wherein the evaluation function comprises a combination of a first evaluation function for evaluating a merit of the hypothesis as an explanation for observation and a second evaluation function for evaluating a merit of the hypothesis as a plan.

(Supplementary Note 4)

The determination device according to Supplementary Note 2 or 3, wherein the observation logical expression comprises a conjunction of a first-order predicate logical expression, and wherein the knowledge base comprises a set of inference rules representing the prior knowledge related to the target system with the first-order predicate logical expression.

(Supplementary Note 5)

The determination device according to any one of Supplementary Notes 1 to 4, further comprising an agent initialization unit configured to initialize a state of the low-level planner to a starting state; and a current state acquisition unit configured to extract a current state of the low-level planner as an input of the hypothesis preparation unit.

(Supplementary Note 6)

The determination device according to any one of Supplementary Notes 1 to 5, wherein the low-level planner comprises an action execution unit configured to determine and execute the actions in accordance with the intermediate state presented by the conversion unit and to receive the reward from the target system.

(Supplementary Note 7)

The determination device according to any one of Supplementary Notes 1 to 6, wherein the low-level planner comprises a state acquisition unit configured to acquire adjacent two intermediate states from a series of the intermediate states; and a low-level planner learning unit configured to loam, in parallel, policy of the low-level planner between the two intermediate states.

(Supplementary Note 8)

A determination method by an information processing device, the method comprising preparing, according to a predetermined hypothesis preparation procedure, a hypothesis including a plurality of logical expressions indicative of a relationship between first information indicative of a certain state among a plurality of states related to a target system and second information indicative of a target state related to the target system; calculating, according to a predetermined conversion procedure, an intermediate state indicated by a logical expression different from a logical expression related to the first information, among the plurality of logical expressions included in the hypothesis; and determining, based on a state-related reward in the plurality of states, actions from the certain state up to the calculated intermediate state.

(Supplementary Note 9)

The determination method according to Supplementary Note 8, wherein the preparing, by the information processing device, comprises converting the target state and the certain state into an observation logical expression which is selected from the plurality of logical expressions; and inferring, based on an evaluation function defining the predetermined hypothesis preparation procedure, the hypothesis from a knowledge base being prior knowledge related to the target system and the observation logical expression.

(Supplementary Note 10)

The determination method according to Supplementary Note 9, wherein the evaluation function comprises a combination of a first evaluation function for evaluating a merit of the hypothesis as an explanation for observation and a second evaluation function for evaluating a merit of the hypothesis as a plan.

(Supplementary Note 11)

The determination method according to Supplementary Note 9 or 10, wherein the observation logical expression comprises a conjunction of a first-order predicate logical expression, and wherein the knowledge base comprises a set of inference rules representing the prior knowledge related to the target system with the first-order predicate logical expression.

(Supplementary Note 12)

The determination method according to any one of Supplementary Notes 9 to 11, wherein the determining includes determining and executing, by the information processing device, the action in accordance with the calculated intermediate state to receive the reward from the target system.

(Supplementary Note 13)

The determination method according to any one of Supplementary Notes 9 to 12, wherein the determining includes acquiring, by the information processing device, adjacent two intermediate states from a series of the intermediate states and learning, in parallel, policy of the determining between the two intermediate states.

(Supplementary Note 14)

A recording medium having recorded thereon a determination program for causing a computer to execute a hypothesis preparation step of preparing, according to a predetermined hypothesis preparation procedure, a hypothesis including a plurality of logical expressions indicative of a relationship between first information indicative of a certain state among a plurality of states related to a target system and second information indicative of a target state related to the target system; a conversion step of calculating, according to a predetermined conversion procedure, an intermediate state indicated by a logical expression different from a logical expression related to the first information, among the plurality of logical expressions included in the hypothesis; and a determination step of determining, based on a state-related reward in the plurality of states, actions from the certain state up to the calculated intermediate state.

(Supplementary Note 15)

The recording medium according to Supplementary Note 14, wherein the hypothesis preparation step comprises an observation logical expression generation step of converting the target state and the certain state into an observation logical expression which is selected from the plurality of logical expressions, and an abduction step of inferring, based on an evaluation function defining the predetermined hypothesis preparation procedure, the hypothesis from a knowledge base being prior knowledge related to the target system and the observation logical expression.

(Supplementary Note 16)

The recording medium according to Supplementary Note 15, wherein the evaluation function comprises a combination of a first evaluation function for evaluating a merit of the hypothesis as an explanation for observation and a second evaluation function for evaluating a merit of the hypothesis as a plan.

(Supplementary mote 17)

The recording medium according to Supplementary Note 15 or 16, wherein the observation logical expression comprises a conjunction of a first-order predicate logical expression, and wherein the knowledge base comprises a set of inference rules representing the prior knowledge related to the target system with the first-order predicate logical expression.

(Supplementary Note 18)

The recording medium according to any one of Supplementary Notes 14 to 17, wherein the determination program causes the computer to further execute an agent initialization step of initializing a state of the determination step into a starting state, and a current state acquisition procedure of extracting a current state of the determination step as an input of the hypothesis preparation step.

(Supplementary Note 19)

The recording medium according to any one of Supplementary Notes 14 to 18, wherein the determination step includes an action execution step of determining and executing the action in accordance with the intermediate state presented by the conversion step and receiving the reward from the target system.

(Supplementary Note 20)

The recording medium according to any one of Supplementary Notes 14 to 19, wherein the determination step includes a state acquisition step of acquiring adjacent two intermediate states from a series of the intermediate states, and a learning step of learning, in parallel, policy of the determination step between the two intermediate states.

### INDUSTRIAL APPLICABILITY

The determination device according to the present invention is applicable to uses such as a plant operating support system or an infrastructure operating support system.

### REFERENCE SIGNS LIST

100, 100A, 100B determination device
110 low-level planner (reinforcement learning agent)
112 action execution unit
110A low-level planner
112A state acquisition unit
114A low-level planner learning unit
120 high-level planner (abduction model)
122 observation logical expression generation unit
124 abduction unit
126 subgoal generation unit
140 knowledge base (background knowledge)
150 agent initialization unit
160 current state acquisition unit

1. A determination device, comprising:
a hypothesis preparation unit configured to prepare, according to a predetermined hypothesis preparation procedure, a hypothesis including a plurality of logical expressions indicative of a relationship between first information indicative of a certain state among a plurality of states related to a target system and second information indicative of a target state related to the target system;
a conversion unit configured to calculate, according to a predetermined conversion procedure, an intermediate state indicated by a logical expression different from a logical expression related to the first information, among the plurality of logical expressions included in the hypothesis; and
a low-level planner configured to determine, based on a state-related reward in the plurality of states, actions from the certain state up to the calculated intermediate state.

2. The determination device as claimed in claim 1, wherein the hypothesis preparation unit comprises:
an observation logical expression generation unit configured to convert the target state and the certain state into an observation logical expression which is selected from the plurality of logical expressions; and
an abduction unit configured to infer, based on an evaluation function defining the predetermined hypothesis preparation procedure, the hypothesis from a knowledge base being prior knowledge related to the target system and the observation logical expression.

3. The determination device as claimed in claim 2, wherein the evaluation function comprises a combination of a first evaluation function for evaluating a merit of the hypothesis as an explanation for observation and a second evaluation function for evaluating a merit of the hypothesis as a plan.

4. The determination device as claimed in claim 2,
wherein the observation logical expression comprises a conjunction of a first-order predicate logical expression, and
wherein the knowledge base comprises a set of inference rules representing the prior knowledge related to the target system with the first-order predicate logical expression.

5. The determination device as claimed in claim 1, further comprising:
an agent initialization unit configured to initialize a state of the low-level planner to a starting state; and
a current state acquisition unit configured to extract a current state of the low-level planner as an input of the hypothesis preparation unit.

6. The determination device as claimed in claim 1,
wherein the low-level planner comprises an action execution unit configured to determine and execute the actions in accordance with the intermediate state presented by the conversion unit and to receive the reward from the target system.

7. The determination device as claimed in claim 1, wherein the low-level planner comprises:
a state acquisition unit configured to acquire adjacent two intermediate states from a series of the intermediate states; and
a low-level planner learning unit configured to learn, in parallel, policy of the low-level planner between the two intermediate states.

8. A determination method by an information processing device, the method comprising:
preparing, according to a predetermined hypothesis preparation procedure, a hypothesis including a plurality of logical expressions indicative of a relationship between first information indicative of a certain state among a plurality of states related to a target system and second information indicative of a target state related to the target system;
calculating, according to a predetermined conversion procedure, an intermediate state indicated by a logical expression different from a logical expression related to the first information, among the plurality of logical expressions included in the hypothesis; and
determining, based on a state-related reward in the plurality of states, actions from the certain state up to the calculated intermediate state.

9. The determination method as claimed in claim 8, wherein the preparing, by the information processing device, comprising:
converting the target state and the certain state into an observation logical expression which is selected from the plurality of logical expressions; and
inferring, based on an evaluation function defining the predetermined hypothesis preparation procedure, the hypothesis from a knowledge base being prior knowledge related to the target system and the observation logical expression.

10. A non-transitory recoding medium recording a determination program causing a computer to execute:
a hypothesis preparation step of preparing, according to a predetermined hypothesis preparation procedure, a hypothesis including a plurality of logical expressions indicative of a relationship between first information indicative of a certain state among a plurality of states related to a target system and second information indicative of a target state related to the target system;
a conversion step of calculating, according to a predetermined conversion procedure, an intermediate state indicated by a logical expression different from a logical expression related to the first information, among the plurality of logical expressions included in the hypothesis; and
a determination step of determining, based on a state-related reward in the plurality of states, actions from the certain state up to the calculated intermediate state.
